(19) United States
(12) Patent Application Publication
(10) Pub. No.: US 2026/0245389 A1
(43) Pub. Date: Aug. 20, 2026

(54) SYSTEM AND METHOD FOR IMAGE AUTHENTICITY

(71) Applicant: JIO PLATFORMS LIMITED, Ahmedabad (IN)

(72) Inventors: Aayush BHATNAGAR, Navi Mumbai (IN); Pradeep Kumar BHATNAGAR, Navi Mumbai (IN); Sundaresh SANKARAN, Mumbai (IN); Haresh B AMBALIYA, Bhundani (IN); Nandakishor VALAKUNDE, Pune (IN); Yogeshwar BARGAL, Chhatripati Sambaji Nagar (IN); Prashant KHATRI, Betul (IN); Yogita Gunjal ROMAN, Indore (IN)

(73) Assignee: JIO PLATFORMS LIMITED, Ahmedabad (IN)

(21) Appl. No.: 18/992,922

(22) PCT Filed: May 27, 2024
(86) PCT No.: PCT/IN2024/050618

§ 371 Date: Jan. 9, 2025

(30) Foreign Application Priority Data
Jun. 28, 2023 (IN) 202321043366

(51) Int. Cl. G06V 20/00; G06F 21/64

(52) U.S. Cl. CPC G06V 20/95; G06F 21/64

(57) ABSTRACT

The present disclosure provides a system (108) and method (500) for image authenticity to verify the originality of images by checking metadata information. The system receives an image(s) from a user. An analyzing unit of the system extracts a set of metadata from the image and analyzes the extracted set of metadata to identify modifications to the image. A validation unit generates validation blocks of timestamps of modifications based on the identification. The analyzing unit analyses the modification and the validation blocks to assess the authenticity of the received image file. A processing unit verifies the authenticity of the received image file based on the analysis.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to image authentication. More particularly, the present disclosure relates to a system and a method for image authenticity to verify the originality of images by checking metadata information.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure and not as an admission of the prior art.

In the digital age, the proliferation of image editing tools and the ease of sharing visual content online has given rise to concerns about image authenticity. The ability to determine whether an image is genuine and unaltered has become increasingly important in domains such as journalism, forensics, advertising, and social media.

With the advancement of technology, it has become relatively easy for individuals to manipulate images, making it challenging to discern between real and altered visual content. Images can be modified in various ways, including adjusting colors, removing, or adding objects, or even creating entirely fabricated scenes. These alterations can be subtle or sophisticated, often fooling unsuspecting viewers and potentially leading to misinformation or deception.

To address these concerns, the concept of image authenticity has emerged. Image authenticity refers to the verification process that aims to establish the originality and integrity of an image, ensuring that it accurately represents the scene captured by the original photographer or creator.

Traditional methods of image authentication primarily rely on visual inspection, subjective judgment, or manual analysis, which are often time-consuming and susceptible to human error. There is, therefore, a need in the art to provide a system and a method that can overcome the shortcomings of the existing prior arts.

### OBJECTS OF THE PRESENT DISCLOSURE

Some of the objects of the present disclosure, which at least one embodiment herein satisfies are as listed herein below.

An object of the present disclosure is to provide a system and a method for image authentication that assists in a verification of image authenticity through examination of the embedded metadata within an image file.

An object of the present disclosure is to provide a system and a method for image authenticity that examines various metadata fields, including timestamps, camera and device information, geolocation data, and editing history.

An object of the present disclosure is to provide a system and a method for image authenticity that uses various techniques to verify the authenticity of the image metadata by making comparisons with known images taken by the same or similar cameras, consulting external data sources like online databases or official records, and conducting forensic analysis using specialized software and techniques.

An object of the present disclosure is to provide a system and a method for image authenticity that evaluates the timestamps associated with the image for consistency and reasonableness, ensuring they align with the claimed time of capture and fall within the expected range based on the technology used.

An object of the present disclosure is to provide a system and a method for image authenticity that reviews the camera make, model, lens information, and other device-specific data to ensure they match the claimed source of the image.

An object of the present disclosure is to provide a system and a method for image authenticity that assesses the geolocation information, if present, to determine if it corresponds to the claimed location of the image.

### SUMMARY

The present disclosure discloses a method for verifying authenticity of an image. The method includes receiving at least one image file captured from at least one computing device. The method includes extracting one or more metadata fields associated with the received image file. The one or more metadata fields represent embedded information associated with the received image file. The method includes analyzing the one or more extracted metadata fields to identify a modification to the image. The method includes generating validation blocks of timestamps of modifications based on the identification. The method includes analyzing the modification, and the validation log to assess the authenticity of the received image file. The method includes verifying the authenticity of the received image file based on the analysis.

In an embodiment, the one or more metadata fields comprise at least one of a timestamp, an image capturing device information, a geolocation data, an editing history data, a file format, a compression artifact, and an exposure setting.

In an embodiment, the step of analyzing the one or more metadata fields further comprises checking an alignment of the extracted timestamp with a claimed time of capture of the received image file, reviewing the extracted image capturing device information by comparing the extracted image capturing device information with a claimed source information stored in a memory, verifying the extracted geolocation data by comparing the extracted geolocation data with a claimed location of the received image file, and analyzing the extracted editing history of the received image file for tracking a modification with the received image file.

In an embodiment, the method further includes a step of verifying the authenticity of the received image file by employing at least one verification technique.

In an embodiment, the at least one verification technique includes metadata comparison, validation using external data sources, forensic analysis, and cross-verification.

In an embodiment, an analyzing unit has been trained to differentiate between authentic images and modified images based on their associated metadata.

In an embodiment, the metadata comparison includes comparing the one or more extracted metadata fields with the metadata fields corresponding to a set of images stored in the memory.

The present disclosure discloses a system for verifying authenticity of an image. The system includes a receiving unit, a memory, an analyzing unit, and a validation unit. The receiving unit is configured to receive at least one image file captured from at least one computing device. The memory is configured to store the at least one received image file. The analyzing unit is configured to cooperate with the memory to receive the image file, and further configured to extract one or more metadata fields associated with the received image file. The one or more metadata fields represent embedded information associated with the received image file. The analyzing unit is configured to process the one or more extracted metadata fields to identify a modification in the image. The validation unit is configured to generate validation blocks of timestamps of modifications based on the identification. The analyzing unit is configured to analyze the modification and the validation log to assess the authenticity of the received image file and verify the authenticity of the based on the analysis.

In an embodiment, the one or more metadata fields comprise at least one of a timestamp, an image capturing device information, a geolocation data, an editing history data, a file format, a compression artifact, and an exposure setting.

In an embodiment, the analyzing unit is further configured to check an alignment of the extracted timestamp with a claimed time of capture of the received image file. The analyzing unit is further configured to review the extracted image capturing device information by comparing the extracted image capturing device information with a claimed source information stored in a memory. The analyzing unit is further configured to verify the extracted geolocation data by comparing the extracted geolocation data with a based on a claimed location of the received image file. The analyzing unit is further configured to analyze the extracted editing history of the received image file for tracking a modification with the received image file.

In an embodiment, the analyzing unit is configured to verify the authenticity of the received image file by employing at least one verification technique.

In an embodiment, the at least one verification technique includes metadata comparison, validation using external data sources, forensic analysis, and cross-verification.

In an embodiment, the includes comparing the one or more extracted metadata fields with the metadata fields corresponding to a set of images stored in the memory.

The present disclosure discloses a user equipment configured to verify authenticity of an image. The user equipment includes a processor, and a computer readable storage medium storing programming instructions for execution by the processor. Under the programming instructions, the processor is configured to receive at least one image file captured from at least one computing device and store the at least one received image file. Under the programming instructions, the processor is configured to extract one or more metadata fields associated with the received image file. The one or more metadata fields represent embedded information associated with the received image file. Under the programming instructions, the processor is configured to process the one or more extracted metadata fields to identify a modification in the image, generate validation blocks of timestamps of modifications based on the identification, analyze the modification and the validation log to assess the authenticity of the received image file; and verify the authenticity of the based on the analysis.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture for implementing a system for verifying the authenticity of an image, in accordance with an embodiment of the present disclosure.

FIG. 2 illustrates an exemplary block diagram of the system, in accordance with an embodiment of the present disclosure.

FIG. 3 illustrates an exemplary flow diagram depicting an authentication flow for images, in accordance with an embodiment of the present disclosure.

FIG. 4 illustrates an exemplary flow diagram illustrating steps performed by the system, in accordance with an embodiment of the present disclosure.

FIG. 5 illustrates an exemplary method for verifying the authenticity of an image, in accordance with an embodiment of the present disclosure.

FIG. 6 illustrates an exemplary computer system in which or with which the embodiments of the present disclosure may be implemented.

The foregoing shall be more apparent from the following more detailed description of the disclosure.

### LIST OF REFERENCE NUMERALS

100—Network Architecture
102-1, 102-2 . . . 102-N—Users
104-1, 104-2 . . . 104-N—Computing Device/Image Capturing Device
108—System
202—Processing Unit
204—Memory
206—A Plurality of Interfaces
208—Receiving Unit
210—Database
212—Analyzing unit
214—Validation Unit
610—External Storage Device
620—Bus
630—Main Memory
640—Read Only Memory
650—Mass Storage Device
660—Communication Port
670—Processor

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

Image authenticity is a crucial aspect in today's digital world where images can be easily manipulated or edited. It refers to the ability to verify that a photograph is an original, unaltered version of the image captured by the original photographer or creator. It is important to ensure that images used in various applications, such as news articles, scientific research, and legal documents, are authentic and have not been tampered with in any way.

To verify the authenticity of an image, the present disclosure is configured to employ metadata analysis. Metadata refers to the information that is embedded in an image file and contains details such as the date and time the photo was taken, Global Positioning System (GPS) coordinates, and username. By analyzing this information, it is possible to verify that the image is authentic and has not been modified in any way. In addition to metadata analysis, a unique hash can be created using the SHA (Secure Hash Algorithms) algorithm and added as metadata information. This provides a secure and tamper-proof record of the image's authenticity. The hash value is unique to each image and is calculated based on the image's content. Even a small change in the image's content will result in a different hash value, making it impossible to modify the image without changing the hash value.

The present disclosure is applicable to all generations of mobile technology, including 2G, 3G, 4G, 5G, 6G, and beyond, with multiple bands and carriers of telecom operators. The present disclosure ensures that the authenticity of images can be verified regardless of the technology used to capture or transmit them.

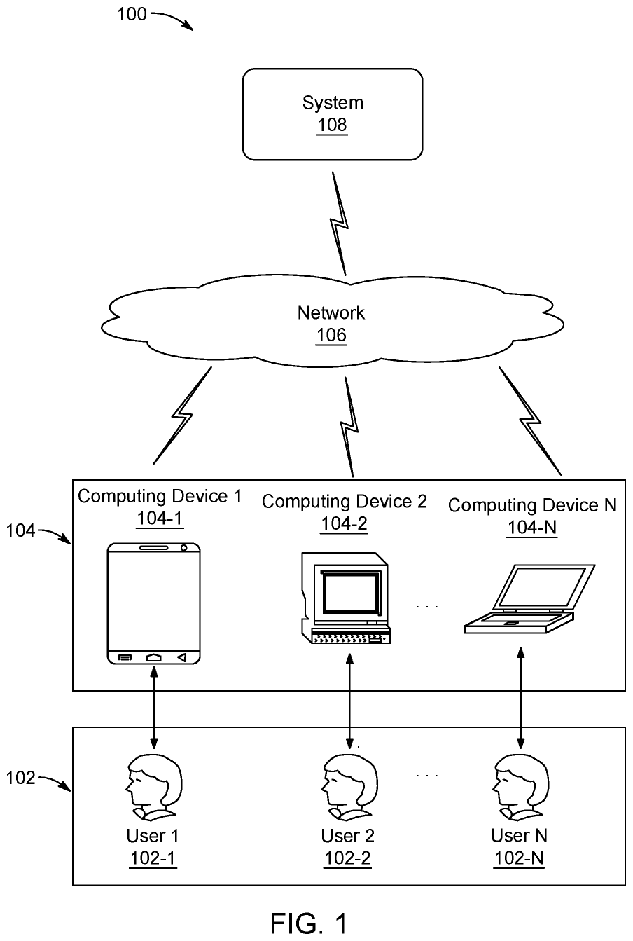

The various embodiments throughout the disclosure will be explained in more detail with reference to FIG. 1-FIG. 6.

FIG. 1 illustrates an exemplary network architecture (100) for implementing a system (108) for verifying the authenticity of an image, in accordance with an embodiment of the present disclosure.

As illustrated in FIG. 1, one or more image capturing devices (104-1, 104-2 . . . 104-N) (also referred as one or more computing devices) may be connected to the system (108) through a network (106). A person of ordinary skill in the art will understand that one or more computing devices (104-1, 104-2 . . . 104-N) may be collectively referred to as computing devices (104) and individually referred to as computing devices (104). One or more users (102-1, 102-2 . . . 102-N) may provide one or more requests to the system (108). A person of ordinary skill in the art will understand that the one or more users (102-1, 102-2 . . . 102-N) may be collectively referred as users (102) and individually referred as a user (102). Further, the computing devices (104) may also be referred as a user equipment (UE) (104) or as UEs (104) throughout the disclosure.

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102), such as a touchpad, touch-enabled screen, electronic pen, and the like, may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may receive at least one image file (hereinafter referred to as ‘image’) from the at least one computing devices (104) through at least one user (102). The system (108) is configured to extract a set of metadata from the received image. The metadata is indicative of embedded information with each of the image file. In an embodiment, the one or more metadata fields comprise at least a timestamp, a camera and device information, a geolocation data, editing history data, a file format, a compression artifact, and an exposure setting. Each of these metadata fields serves a specific purpose in describing the characteristics or history of a digital file. The timestamp records the date and time when the file was created or modified. The image capturing device information (Camera and device information) specifies details about the device used to capture the file, such as the make and model of the image capturing device (camera or smartphone). Geolocation data provides information about where the file was captured, often in the form of GPS coordinates. Editing history data tracks the changes made to the file over time, including any edits or modifications. The file format indicates the type of file (e.g., JPEG, PNG, RAW) and its structure. The compression artifact describes any artifacts or distortions introduced by file compression techniques. The exposure setting records the camera's exposure settings at the time the file was captured, such as aperture, shutter speed, and ISO. These metadata fields help the system to manage and understand digital files (image files) more effectively. They can be especially useful for organizing, searching, and analyzing large collections of the files.

The system (108) is configured to use an analyzing unit (in an example the analyzing unit is an Artificial Intelligence (AI) model) is configured to analyze the extracted set of metadata by comparing one or more metadata fields against known standards and expectations. For example, the system (108) is configured to check if the timestamp aligns with a claimed time of capture of the image file. The system (108) is configured to review the camera and device information and also checks the geolocation data based on a context and content of the image file. In an aspect, the context and content of one or more image files encompass both the circumstances surrounding their creation or usage and the visual information they contain. The context includes details such as where and when the images were captured, the purpose behind their creation, and any relevant events or activities at the time. On the other hand, the content refers to the actual visual elements depicted in the images, such as objects, people, colors, and textures. Understanding both aspects is essential for interpreting the images effectively, extracting meaningful information, and grasping their overall significance or message. The system (108) is configured to analyze the editing history of the image file.

In an embodiment, the system (108) is configured to compare the extracted metadata with a predetermined metadata stored in a memory corresponding to one or more images taken by similar cameras for the identification of inconsistencies and anomalies in the set of metadata.

In one embodiment, the system (108) is configured to check with one or more external sources to verify the accuracy and authenticity of each metadata field. This process helps ensure that the metadata is reliable and can be used for further analysis or processing.

Furthermore, in another embodiment, the system (108) is configured to conduct a thorough analysis, including forensic analysis, of the metadata set. It performs pixel-level examination to detect any anomalies or irregularities in the image. Additionally, the system (108) uses specialized software and techniques to validate the image's integrity to ensure it is not tampered with or corrupted.

Moreover, the system (108) is configured to cross-check the information conveyed by each image with other sources to further authenticate the image's validity. This cross-verification process adds an extra layer of security to the system, ensuring that only genuine and untampered images are accepted and processed.

In an operative aspect, the system (100) is configured to perform the following exemplary steps:
1. Source Verification: The first step is to verify an original source of the image. This can be done by determining if it originates from a reliable and trustworthy source, such as a field engineer or a reputable device. It's important to be cautious of images shared on unverified platforms or through unofficial channels, as these sources may not be credible.
2. Metadata Examination: A second step in verifying the authenticity of an image is to examine the metadata. Image metadata includes information such as the date and time the photo was taken, camera settings, and GPS coordinates. This data can be accessed by examining the properties of the image file or by using image authenticator software. Inconsistencies or discrepancies in metadata could indicate tampering or manipulation.
3. Forensic Analysis: In cases where image authenticity is crucial, the forensic analysis can be performed by experts using image authenticator software. This involves examining image metadata and site information for authentic images. Forensic analysis is a more in-depth process that can provide a higher level of certainty about the authenticity of an image.
4. Cross-Verification: At last step, cross-verify the information conveyed by the image with other reliable sources, such as field engineer manager accounts. This can help provide additional context and information that can be used to verify the authenticity of the image.

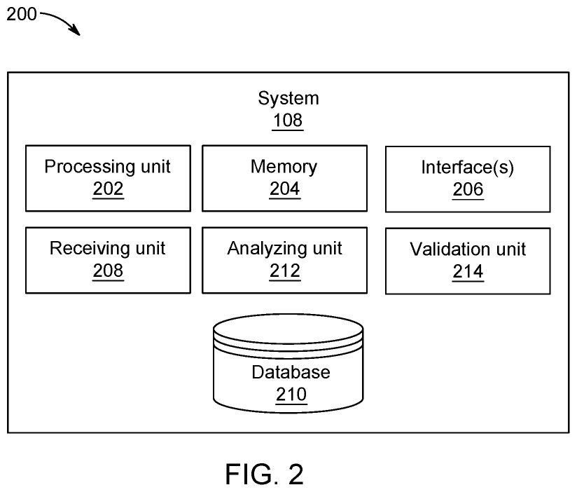

FIG. 2 illustrates an exemplary block diagram (200) of the system (108), in accordance with an embodiment of the present disclosure.

Referring to FIG. 2, in an embodiment, the system (108) includes a processing unit (202), a receiving unit (208), and a memory (204). The processing unit (202) may be implemented as one or more microprocessors, microcomputers, microcontrollers, digital signal processors, central processing units, logic circuitries, and/or any devices that process data based on operational instructions. Among other capabilities, the processing unit (202) may be configured to fetch and execute computer-readable instructions stored in the memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output devices (I/O), storage devices, and the like. The interface(s) (206) may facilitate communication through the system (108). The interface(s) (206) may also provide a communication pathway for one or more components of the system (108). Further, the processing unit may include a data parameter engine and other engine(s). In an embodiment, the other engine(s) may include, but not limited to, a data ingestion engine, an input/output engine, and a notification engine.

In an embodiment, the processing unit (202) may be implemented as a combination of hardware and programming (for example, programmable instructions) to implement one or more functionalities of the processing unit. In examples described herein, such combinations of hardware and programming may be implemented in several different ways. For example, the programming for the processing unit may be processor-executable instructions stored on a non-transitory machine-readable storage medium and the hardware for the processing unit may comprise a processing resource (for example, one or more processors), to execute such instructions. In the present examples, the machine-readable storage medium may store instructions that, when executed by the processing resource, implement the processing unit. In such examples, the system may comprise the machine-readable storage medium storing the instructions and the processing resource to execute the instructions, or the machine-readable storage medium may be separate but accessible to the system and the processing resource.

The receiving unit (208) is configured to receive at least one image file captured from at least one computing device. The memory (204) is configured to store the at least one received image file.

In an embodiment, the processing unit (202) is configured to receive the at least one image (as an input) via the receiving unit (208). The at least one image may be received from the one or more computing devices (104) associated with the one or more users (102). The processing unit (202) is configured to cooperate with the memory to receive the image file and is further configured to extract one or more metadata fields associated with the received image file. The processing unit (202) may store the input in the database (210). The one or more metadata fields represent embedded information associated with the received image file. In an example, the one or more metadata fields include at least one of a timestamp, an image capturing device information, a geolocation data, an editing history data, a file format, a compression artifact, and an exposure setting.

In an embodiment, the system (108) further includes an analyzing unit (212). The processing unit (202) is configured to utilize the analyzing unit (212) to extract one or more metadata fields associated with the received image file, wherein the one or more metadata fields represent embedded information associated with the received image file. In examples, the analyzing unit (212) may use programming libraries, application programming interfaces (APIs) and other tools to extract the one or more metadata fields. The processing unit (202) is configured to utilize the analyzing unit (212) to analyze one or more extracted metadata fields to identify possible modifications to the image. In examples, the analyzing unit (212) is a trained AI unit (AI model) that is trained using a dataset comprising authentic and modified digital images and their corresponding one or more metadata fields. The AI model is trained to learn to differentiate between authentic images and images that have been modified with or manipulated based on the one or more metadata fields. Further, the analyzing unit (212) may identify a number of times the image may have been modified based on the analysis of the one or more metadata fields.

In an embodiment, for assessing the authenticity of the received image file the analyzing unit (212) is configured to check an alignment of the extracted timestamp with a claimed time of capture of the received image file. If the extracted timestamp is not matched with the claimed time of capturing the image file, it implies that the received image file is tempered and not authenticated. The analyzing unit (212) is further configured to review the extracted image capturing device information by comparing the extracted image capturing device information with a claimed source information stored in the memory. For example, the image-capturing device is a camera or a computing device. For example, the image-capturing device information, including make, model, lens information, and other device-specific data, are reviewed to ensure they match the claimed source of the image. Based on the comparison, if any inconsistency is detected, it raises doubts about the image's authenticity.

The analyzing unit (212) is further configured to verify the extracted geolocation data by comparing it with a claimed location of the received image file. If geolocation information is present in the image, the analyzing unit (212) is configured to determine if it corresponds to the claimed location of the image. The geolocation data is checked for plausibility based on the context and content of the image. The analyzing unit (212) is further configured to analyze the extracted editing history of the received image file for tracking a modification with the received image file. For example, some image formats store information about the editing history of the image. This includes details about modifications, compression, and previous saves. Analyzing the editing history can reveal if the image has been tampered with or altered. The analyzing unit (212) is configured to verify the analyzed metadata fields to verify the authenticity of the received image file by employing at least one verification technique. In an example, the at least one verification technique includes metadata comparison, validation using external data sources, forensic analysis, and cross-verification. The metadata comparison includes comparing the one or more extracted metadata fields with the metadata fields corresponding to a set of images stored in the memory. The validation of metadata fields includes validating through the use of external sources like online databases, official records, or reference sources. Geolocation data, for example, can be validated using location databases or maps. The forensic analysis involves advanced examination of metadata, pixel-level analysis, and image integrity validation. The cross-verification process includes confirming the information conveyed by the image with other reliable sources such as field engineer manager accounts. In an embodiment, the analyzing unit (212) may compare the extracted metadata with predetermined metadata from one or more images taken by similar cameras for the identification of inconsistencies and anomalies in the set of metadata. In an embodiment, the analyzing unit (212) is configured to consult one or more external sources to validate the one or more metadata fields. In an embodiment, the analyzing unit (212) is configured to conduct analysis, such as forensic analysis, of the set of metadata, perform pixel-level examination, and validate image integrity using one or more specialized software and techniques.

In examples, the AI model includes one or more neural networks to perform the analysis of the one or more metadata fields and generate an authentication score or confidence level indicating the likelihood that the digital image is authentic. The analyzing unit (212) is iteratively refined based on differences between predicted authentication scores generated by the AI model and ground truth labels indicating the authenticity of digital images in training and validation datasets. The analyzing unit (212) is connected to external sources, databases, network of image analyst's tools to obtain, learn and improve differentiation ability by continuously assessing original and modified images or obtaining knowledge about modifications. As a result, the analyzing unit (212) adapts to evolving manipulation techniques in a digital landscape.

In an aspect, the analyzing unit (212) analyzes the image to detect any signs of manipulation or tampering. This can include identifying inconsistencies in lighting, shadows, or pixel patterns. Next, the analyzing unit (212) compares the image against known databases or reference images to determine its authenticity. In an example, the analyzing unit (212) may employ techniques such as watermarking or digital signatures to encode information directly into the image, enabling easy verification of its origin and integrity.

In an embodiment, the system (108) also includes a validation unit (214). The processing unit (202) is configured to utilize the validation unit (214) to generate validation blocks of timestamps of modifications based on the identification. In an aspect, the validation unit (214) is a blockchain unit. In examples, the validation unit (214) generates a first validation block based on base metadata of the one or more extracted metadata. The base metadata refers to metadata that was part of original metadata when the image was formed. Based on the analysis by the analyzing unit (212), the validation unit (214) generates additional validation blocks. For examples, on identification of modification based on metadata, the validation unit (214) generates a new validation block. To elaborate, there may be one or more modifications to the image. Each modification may modify the one or more metadata fields. For example, change in file format and compression may cause changes in metadata. Similarly, metadata may include software used in modification. In examples, some metadata may include editing history. Other examples include metadata having date and time of modifications. Each of such modifications is identified by the validation unit (214), and validation blocks of timestamps of modifications are generated in chronological order capturing the modifications to the image to indicate a chronology of the changes to the image.

The processing unit (202) is configured to utilize the analyzing unit (212) to assess the authenticity of the image based on the modification and the validation blocks. In examples, if there are multiple blocks, it indicates that the image has been modified. Based on the analysis and assessment, the system 108 verifies the authenticity of the received image file.

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

In an overall aspect, image metadata authenticity is a crucial aspect of verifying the reliability and accuracy of image files. Image metadata includes a range of information, such as the date and time of creation, the type of camera used to capture the image, the location where the image was taken, and any editing or manipulation that has been done to the image. The authenticity of this metadata is essential for determining the trustworthiness of an image and its origin, creation, and history. By evaluating metadata, such as timestamps, camera details, geolocation data, and editing history, the system is configured to determine if the image accurately represents its origin, creation, and history. For example, if the metadata indicates that an image was taken in a specific location at a certain time, but the image appears to have been taken at a different time or place, this could indicate that the image has been manipulated or tampered with.

The system (108) is configured to verify whether the image has been modified or tampered with, ensuring that it aligns with the claimed source and context. This can help combat misinformation and promote the use of reliable and authentic images in various domains. For instance, in journalism or legal proceedings, authentic images are essential to support claims and provide evidence.

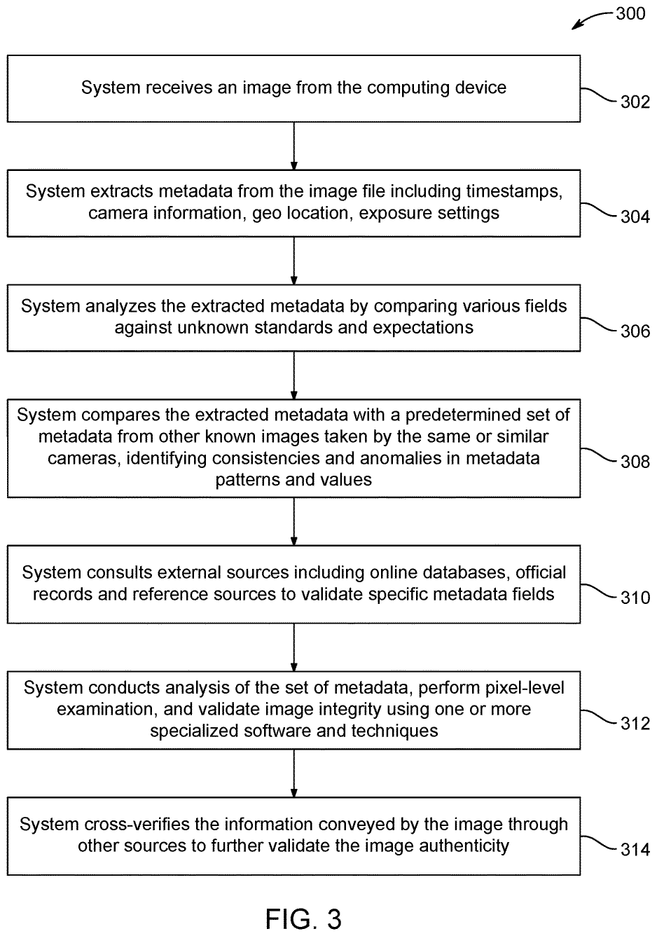

FIG. 3 illustrates an exemplary flow diagram (300) depicting an authentication flow for images, in accordance with an embodiment of the present disclosure. As illustrated in FIG. 3, the following steps may be implemented by the system (108) for the implementation of image authentication.
At step 302: The system (108) receives at least one image from at least one computing device (104) associated with at least one user (102).
At step 304: The system (108) extracts metadata from the image file, including timestamps, camera and device information, geolocation data, exposure settings, editing history data, a file format, and a compression artifact.
At step 306: The system (108) analyzes the extracted metadata by comparing various metadata fields against known standards and expectations, including evaluating the consistency and reasonableness of timestamps, reviewing camera and device information for consistency with the claimed source, assessing the plausibility of geolocation data based on the context of at least one images, and analyzing the editing history to detect any tampering or alterations.
At step 308: The system (108) compares the extracted metadata with a predetermined set of metadata from other known images taken by the same or similar cameras, identifying inconsistencies and anomalies in metadata patterns and values.
At step 310: The system (108) consults external sources, including online databases, official records, and reference sources, to validate specific metadata fields. The specific metadata fields may include verifying geolocation data using maps or location databases.
At step 312: The system (108) conducts analysis, such as forensic analysis, of the set of metadata, performs pixel-level examination, and validates image integrity using one or more specialized software and techniques.
At step 314: The system (108) cross-verifies the information conveyed by the image through other sources to validate the image authenticity.

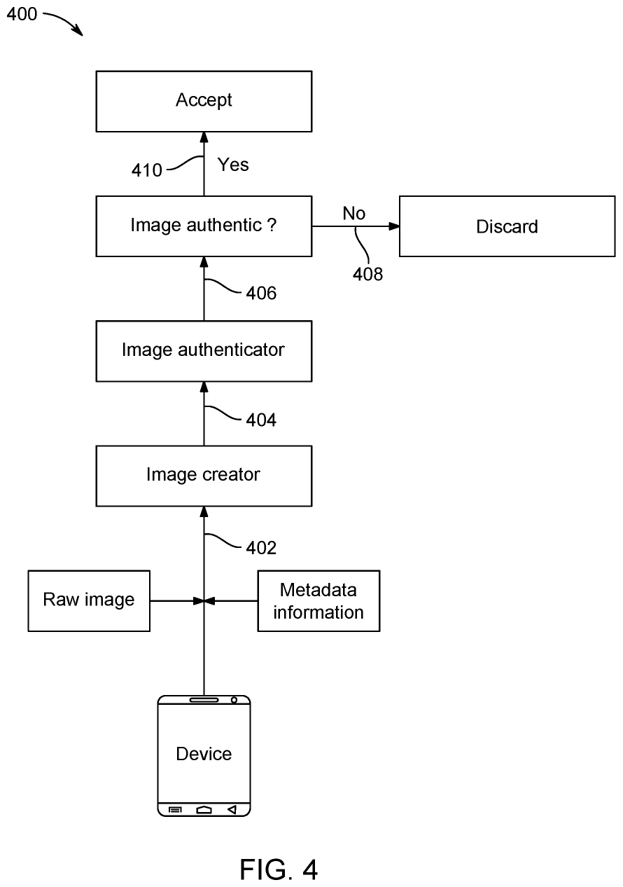

FIG. 4 illustrates an exemplary flow diagram illustrating steps performed by the system, in accordance with an embodiment of the present disclosure. In an aspect, the system may be implemented on a receiving node or a transmitting node.

At step 402, an image creator (image creator application) is configured to receive a raw image and accompanying metadata from the mobile device. The image creator then processes the received data to embed the metadata into the image, resulting in an embedded image that contains both the visual content and the accompanying metadata. The image creator is commonly used for various purposes such as adding location information, timestamps, or other descriptive data to images captured by the mobile device. The embedded metadata can provide additional context or information about the image, which can be useful for organizing, searching, or sharing the images later on. The process may involve extracting the metadata from the mobile device's data stream, formatting it in a standardized way, and then embedding it into the image file using data embedding techniques or other metadata embedding methods. Once the metadata is embedded, the resulting image can be saved or shared like any other image file, with the embedded information intact. This allows for easy retrieval and interpretation of the metadata by other applications or devices that support the same standards for metadata extraction.

At step (404), an image authenticator (the system) is configured to receive the embedded image from the image creator. The image authenticator is configured to verify the authenticity or integrity of the embedded image to ensure that it hasn't been tampered with or altered since its creation. To achieve this, the image authenticator may analyze metadata such as timestamps, camera information, geolocation data, and editing history, to determine if the received image accurately represents its origin, creation, and history. The goal is to verify if the image has been manipulated or tampered with, ensuring that it aligns with the claimed source and context.

At step (406), the image authenticator is configured to provide a verification or authentication result, indicating whether the image is deemed authentic or if there are indications of tampering or alteration. This verification can be crucial for applications where the integrity and authenticity of images are paramount, such as forensic analysis, legal documentation, or authentication in digital workflows. At step (408), if the received image is deemed unauthentic, the image authenticator discards the received image. At step (410), if the received image is deemed authentic, the image authenticator accepts the received image.

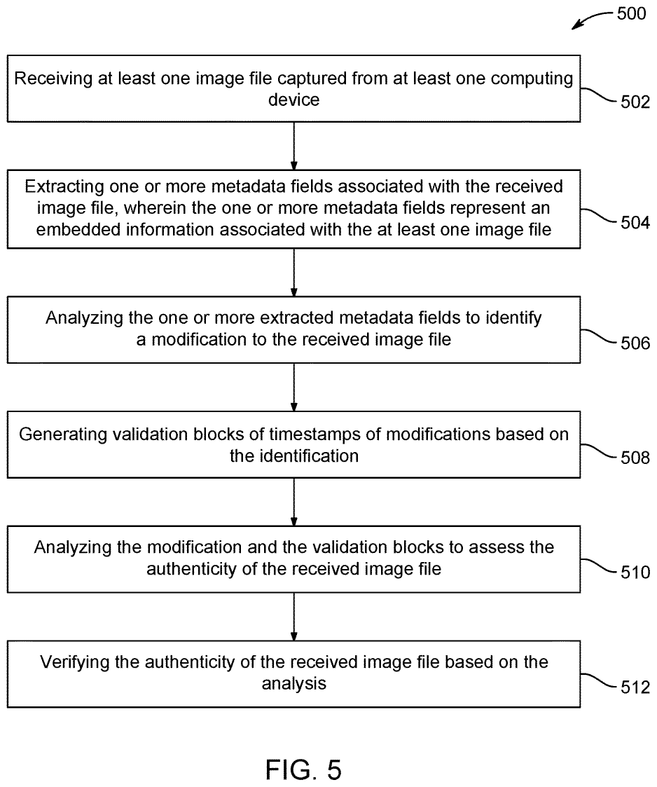

FIG. 5 illustrates an exemplary method (500) for verifying the authenticity of the image, in accordance with an embodiment of the present disclosure.
At step (502), the system is configured to receive the at least one image file captured from the at least one computing device (or an image capturing device). For example, the image capturing device is a camera, a user equipment, or a computing device.
At step (504), the system is configured to extract one or more metadata fields associated with the received image file using the artificial intelligence (AI) unit (212). The one or more metadata fields represent embedded information associated with the received image file. In an example, the one or more metadata fields comprise at least one of a timestamp, an image capturing device information, a geolocation data, an editing history data, a file format, a compression artifact, and an exposure setting.
At step (506), the system is configured to analyze the one or more extracted metadata fields to identify a modification to the image.
At step (508), the system (validation unit (214)) is configured to generate validation blocks of timestamps of modifications based on the identification.
At step (510), the system is configured to analyse the modification and the validation blocks to assess the authenticity of the received image file. In an aspect, the system may be configured to analyse the modification by employing at least one verification technique. In an example, the at least one verification technique includes metadata comparison, validation using external data sources, forensic analysis, and cross-verification. For example, the metadata comparison includes comparing the one or more extracted metadata fields with the metadata fields corresponding to a set of images stored in the memory.

In an embodiment, the step of analyzing the one or more metadata fields further includes checking the alignment of the extracted timestamp with the claimed time of capture of the received image file.

The step of analyzing further includes reviewing the extracted image-capturing device information by comparing the extracted image-capturing device information with a claimed source information stored in the memory. The step of analyzing includes verifying the extracted geolocation data by comparing the extracted geolocation data with a claimed location of the received image file.

The step of analyzing includes analyzing the extracted editing history of the received image file for tracking a modification with the received image file.
At step (512), the system is configured to verify the authenticity of the received image file based on the analysis.

In an aspect, the present disclosure discloses a user equipment that is configured to verify the authenticity of an image. The user equipment includes a processor and a computer-readable storage medium storing programming instructions for execution by the processor. Under the programming instructions, the processor is configured to receive at least one image file captured from at least one computing device and store the at least one received image file. Under the programming instructions, the processor is configured to extract one or more metadata fields associated with the received image file. The one or more metadata fields represent embedded information associated with the received image file. The one or more metadata fields represent embedded information associated with the received image file. Under the programming instructions, the processor is configured to process the one or more extracted metadata fields to identify a modification in the image, generate validation blocks of timestamps of modifications based on the identification, analyze the modification and the validation log to assess the authenticity of the received image file; and verify the authenticity of the based on the analysis.

The system is configured to determine image authenticity by examining the embedded information in an image file to ensure that it accurately represents the image's origin, creation, and history. In an operational aspect, the system is configured to employ the following steps:
1. Extraction: First, the metadata is extracted from the image file. Most image formats include metadata within the file itself, which can include timestamps, camera information, geolocation, exposure settings, and more.
2. Metadata Analysis: Once the metadata is extracted, the system is configured to analyze the extracted metadata for authenticity by examining various metadata fields and comparing them against known standards and expectations. In an example, the metadata analysis include:
   a. Timestamps: The timestamps associated with the image are evaluated for consistency and reasonableness. This involves checking if the timestamps align with the claimed time of capture, as well as verifying if they are within the expected range based on the technology used.
   b. Camera and Device Information: The camera make, model, lens information, and other device-specific data are reviewed to ensure they match the claimed source of the image. Any inconsistencies in this information may raise doubts about the image's authenticity.
   c. Geolocation Data: If geolocation information is present, it is assessed to determine if it corresponds to the claimed location of the image. The geolocation data is checked for plausibility based on the context and content of the image.
   d. Editing History: Some image formats store information about the editing history of the image. This includes details about modifications, compression, and previous saves. Analysing the editing history can reveal if the image has been tampered with or altered.
3. Verification Techniques: Various techniques can be employed to verify the authenticity of the image metadata. These techniques include:
   a. Comparisons: The extracted metadata can be compared with other known images taken by the same camera model or similar cameras. By comparing metadata patterns and values, inconsistencies or anomalies can be identified.
   b. External Data Sources: External sources like online databases, official records, or reference sources can be consulted to validate specific metadata fields. For example, geolocation data can be verified using maps or location databases.
   c. Forensic Analysis: In cases where image authenticity is crucial, experts may conduct forensic analysis using specialized software and techniques. This can involve advanced metadata analysis, pixel-level examination, and validation of image integrity.
   d. Cross-Verification: It's important to cross-verify the information conveyed by the image with other reliable sources, such as field engineer manager accounts.

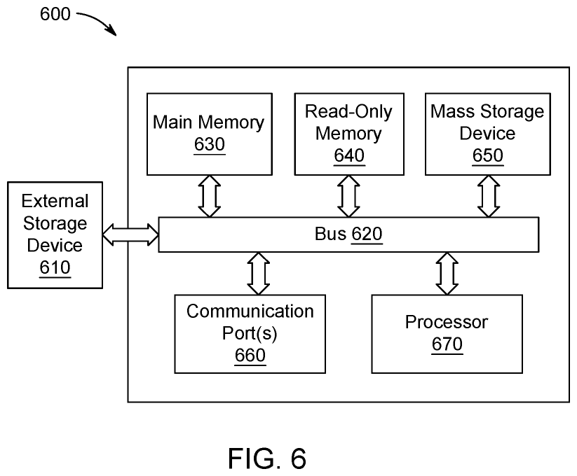

FIG. 6 illustrates an exemplary computer system (600) in which or with which the embodiments of the present disclosure may be implemented.

As shown in FIG. 6, the computer system (600) may include an external storage device (610), a bus (620), a main memory (630), a read-only memory (640), a mass storage device (650), a communication port(s) (660), and a processor (670). A person skilled in the art will appreciate that the computer system (600) may include more than one processor and communication ports. The processor (670) may include various modules associated with embodiments of the present disclosure. The communication port(s) (660) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (660) may be chosen depending on a network, such as a Local Area Network (LAN), Wide Area Network (WAN), or any network to which the computer system (600) connects.

In an embodiment, the main memory (630) may be Random Access Memory (RAM), or any other dynamic storage device commonly known in the art. The read-only memory (640) may be any static storage device(s) e.g., but not limited to, a Programmable Read Only Memory (PROM) chip for storing static information e.g., start-up or basic input/output system (BIOS) instructions for the processor (670). The mass storage device (650) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (620) may communicatively couple the processor(s) (670) with the other memory, storage, and communication blocks. The bus (620) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (670) to the computer system (600).

In another embodiment, operator and administrative interfaces, e.g., a display, keyboard, and cursor control device may also be coupled to the bus (620) to support direct operator interaction with the computer system (600). Other operator and administrative interfaces can be provided through network connections connected through the communication port(s) (660). Components described above are meant only to exemplify various possibilities. In no way should the aforementioned exemplary computer system (600) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method for image authenticity that examine the embedded information within an image file to verify the authenticity of the image.

The present disclosure provides a system and a method for image authenticity that provides an objective approach to determining image authenticity by relying on verifiable data and known standards, reducing the reliance on subjective judgments or assumptions.

The present disclosure provides a system and a method for image authenticity that analyses the metadata to ensure that the image has not been tampered with or altered.

The present disclosure provides a system and a method for image authenticity that compares the image's metadata patterns and values with other known images taken by the same or similar cameras to identify inconsistencies or anomalies.

The present disclosure provides a system and a method for image authenticity that utilizes specialized software and forensic analysis techniques to provide advanced scrutiny of metadata, pixel-level examination, and image integrity validation.

1. A method for verifying an authenticity of an image, the method comprising:
receiving at least one image file captured from at least one computing device;
extracting one or more metadata fields associated with the received image file, wherein the one or more metadata fields represent embedded information associated with the received image file;
analyzing the one or more extracted metadata fields to identify a modification to the image;
generating validation blocks of timestamps of the modification based on the identification;
analyzing the modification and the validation blocks to assess the authenticity of the received image file; and
verifying the authenticity of the received image file based on the analysis.

2. The method as claimed in claim 1, wherein the one or more metadata fields comprise at least one of a timestamp, an image capturing device information, a geolocation data, an editing history data, a file format, a compression artifact, and an exposure setting, and wherein analyzing the one or more metadata fields further comprises:
checking an alignment of the extracted at least one of the timestamp with a claimed time of capture of the received image file;
reviewing the extracted image capturing device information by comparing the extracted image capturing device information with a claimed source information stored in a memory;
verifying the extracted geolocation data by comparing the extracted geolocation data with the claimed source location of the received image file; and
analyzing the extracted editing history of the received image file for tracking a modification with the received image file.

3. The method as claimed in claim 1, further comprising of verifying the authenticity of the received image file by employing at least one verification technique.

4. The method as claimed in claim 3, wherein the at least one verification technique includes metadata comparison, validation using external data sources, forensic analysis, and cross-verification.

5. The method as claimed in claim 4, wherein the metadata comparison includes comparing the one or more extracted metadata fields with the metadata fields corresponding to a set of images stored in the memory.

6. The method as claimed in claim 1, wherein an analyzing unit is trained to differentiate between authentic images and modified images based on their associated metadata.

7. A system for verifying an authenticity of an image, the system comprising:
a receiving unit configured to receive at least one image file captured from at least one computing device;
a memory configured to store the at least one received image file;
an analyzing unit configured to cooperate with the memory to receive the image file, and further configured to:
extract one or more metadata fields associated with the received image file, wherein the one or more metadata fields represent embedded information associated with the received image file; and
process the one or more extracted metadata fields to identify a modification in the image;
a validation unit configured to generate validation blocks of timestamps of the modification based on the identification;
the analyzing unit is further configured to analyze the modification and the validation log to assess the authenticity of the received image file; and
verify the authenticity of the received image file based on the analysis.

8. The system as claimed in claim 7, wherein the one or more metadata fields comprise at least one of a timestamp, an image capturing device information, a geolocation data, an editing history data, a file format, a compression artifact, and an exposure setting, wherein, the analyzing unit is further configured to:
check an alignment of the extracted at least one of the timestamp with a claimed time of capture of the received image file;
review the extracted image capturing device information by comparing the extracted image capturing device information with a claimed source information stored in the memory;
verify the extracted geolocation data by comparing the extracted geolocation data with the claimed location of the received image file; and
analyze the extracted editing history of the received image file for tracking a modification with the received image file.

9. The system as claimed in claim 7, wherein the analyzing unit is configured to verify the authenticity of the received image file by employing at least one verification technique.

10. The system as claimed in claim 9, wherein the at least one verification technique includes metadata comparison, validation using external data sources, forensic analysis, and cross-verification.

11. The system as claimed in claim 10, wherein the metadata comparison includes comparing the one or more extracted metadata fields with the metadata fields corresponding to a set of images stored in the memory.

12. (canceled)

13. A computer program product comprising a non-transitory computer-readable medium comprising instructions that, when executed by one or more processors, cause the one or more processors to:
receive at least one image file captured from at least one computing device;
store the at least one received image file;
extract one or more metadata fields associated with the received image file, wherein the one or more metadata fields represent embedded information associated with the received image file; and
process the one or more extracted metadata fields to identify a modification in the image;
generate validation blocks of timestamps of the modification based on the identification;
analyze the modification and the validation log to assess the authenticity of the received image file; and
verify the authenticity of the received image file based on the analysis.

14. The system as claimed in claim 7, wherein the analyzing unit is trained to differentiate between authentic images and modified images based on their associated metadata.
